(19) United States
(12) Patent Application Publication
(10) Pub. No.: US 2010/0222030 A1
(43) Pub. Date: Sep. 2, 2010

(54) SYSTEM AND METHOD FOR SENDING AN AUDIO MESSAGE BY MOBILE PHONE DURING COMMUNICATION

(75) Inventors: HONG-LIANG LIU, Shenzhen City (CN); AI-TING ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONGFU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/482,047

(22) Filed: Jun. 10, 2009

(30) Foreign Application Priority Data
Mar. 2, 2009 (CN) 200910300642.2

(51) Int. Cl. H04M 11/10

(52) U.S. Cl. 455/413

(57) ABSTRACT

A system and method is used for transmitting an audio message by mobile phones during communication with a remote terminal. The system includes a detecting module, a storage module, a voice processing module, and an output control module. The detecting module detects whether the mobile phone is communicating with the remote terminal, and transmits a busy signal to the storage module when the mobile phone is communicating with the remote terminal. The storage module stores a plurality of digital voice signals, and transmits the corresponding digital voice signal to the voice processing module when receives the busy signal. The voice processing module converts the corresponding digital voice signal to audible voice message, and transmits the audible voice message to an output control module. The output control module transmits the audible voice message from the voice processing module to the remote terminal together with communicating voice message.

### BACKGROUND

1. Technical Field

The present disclosure relates to a system and method, particularly to a system and method for sending an audio message by mobile phones during communication.

2. Description of Related Art

Mobile devices provide various communication applications for different users. Currently, users may communicate with each other through mobile phones. However, users may receive some unwanted calls and want to end the telephone call as soon as possible. But sometimes it is impolite to hang up the phone directly.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of the system for sending an audio message by mobile phones during communication.

FIG. 2 is a flow chart of recording voice message in the system of FIG. 1.

FIG. 3 is a flow chart of a method of sending an audio message by mobile phones during communication via the system of FIG. 1.

### DETAILED DESCRIPTION

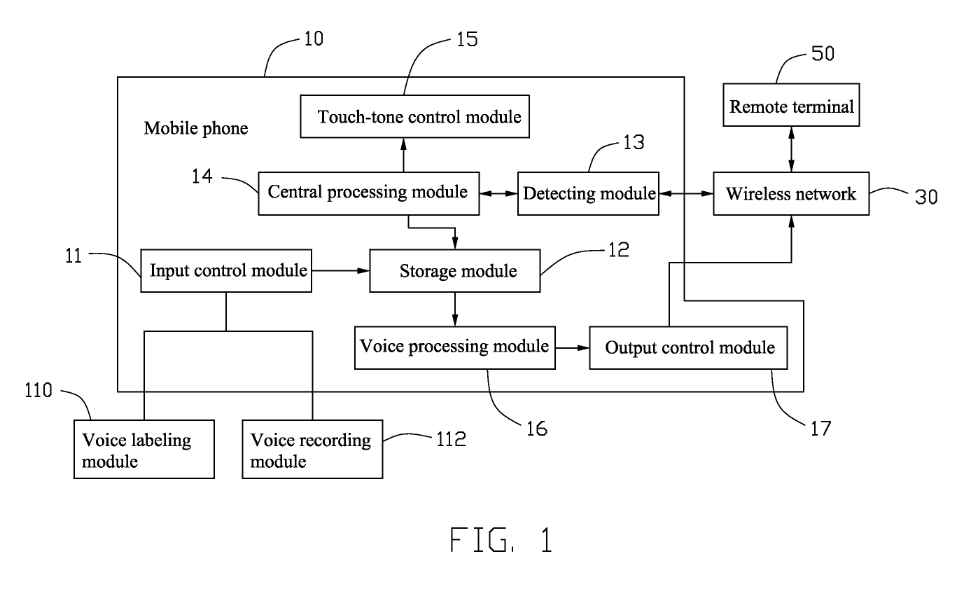

Referring to FIG. 1, a system for sending an audio message by mobile phones during communication includes a mobile phone 10, and a remote terminal 50 (which can be another mobile phone). The mobile phone 10 is connected to the remote terminal 50 via a wireless network 30.

The mobile phone 10 includes an input control module 11, a storage module 12, a detecting module 13, a central processing module 14, a touch-tone control module 15, a voice processing module 16, and an output control module 17. The input control module 11 records voice messages, and converts the recorded voice messages to digital voice signal. The storage module 12 is configured to store the digital voice signals. The detecting module 13 detects whether the mobile phone 10 is communicating with the remote terminal 50, and outputs a busy signal when the mobile phone 10 is communicating with the remote terminal 50. The central processing module 14 receives the busy signal from the detecting module 13, detects whether a touch-tone of the mobile phone 10 is turned off, and transmits the busy signal to the storage module 12 when the touch-tone is turned off. The touch-tone control module 15 turns off the touch-tone of the mobile phone 10 when the central processing module 14 detects that the touch-tone is turned on. The storage module 12 transmits the corresponding digital voice signal to the voice processing module 16 when receives the busy signal from the central processing module 14. The voice processing module 16 converts the corresponding digital voice signal to audible voice message, and transmits the audible voice message to the output control module 17. The output control module 17 transmits the audible voice message from the voice processing module 16 to the remote terminal 50 together with communicating voice message.

The input control module 11 includes a voice labeling module 110 and a voice recording module 112. The voice labeling module 110 includes ten information columns corresponding to the ten numeral keys from 0˜9 on the mobile phone 10. The voice recording module 112 can record ten voice messages corresponding to the ten information columns.

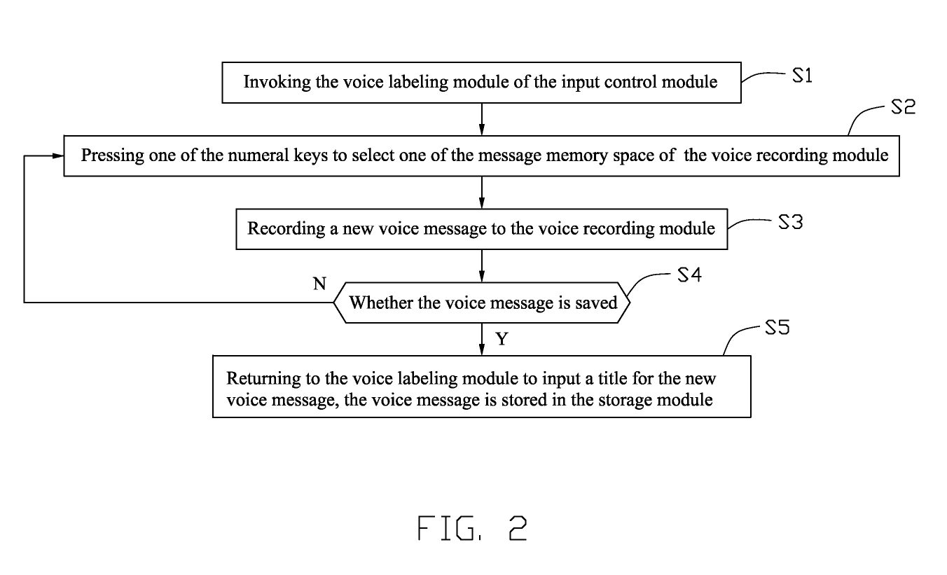

Referring to FIG. 2, a flow chart of recording voice message in the system of FIG. 1 includes the following steps:

In Step S1: invoking the voice labeling module 110 of the input control module 11;

In Step S2: pressing one of the numeral keys to select one of the message memory space of the voice recording module 112;

In Step S3: recording a new voice message to the voice recording module 112;

In Step S4: if the voice message is not saved, Step S2 is repeated;

In Step S5: if the voice message is saved, returns to the voice labeling module 110 to input a title for the new voice message, the voice message is stored in the storage module 12.

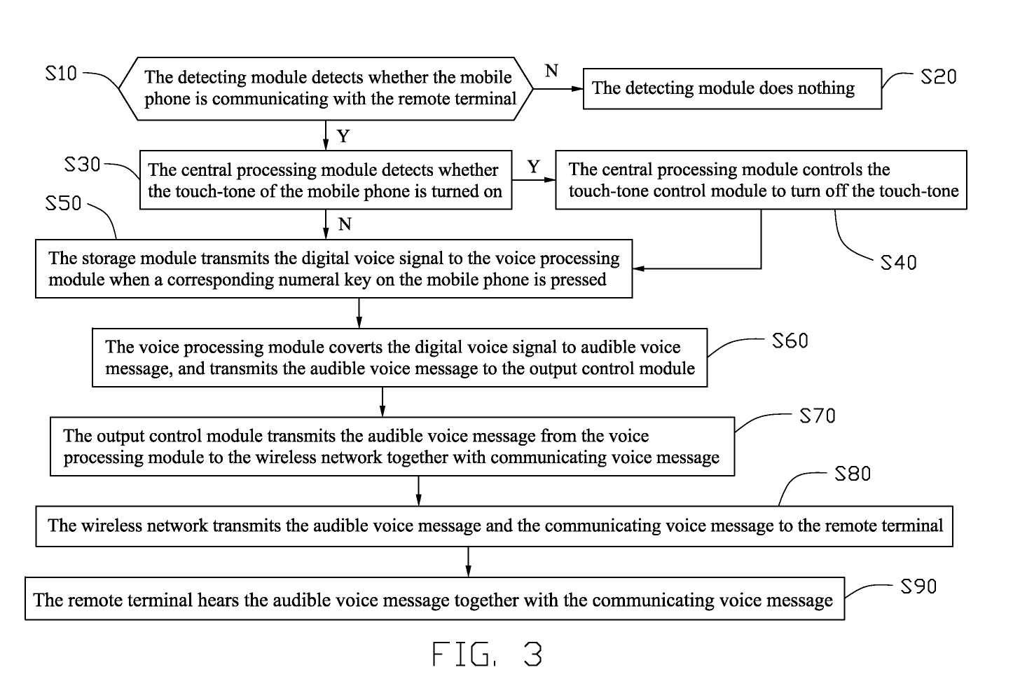

Referring to FIG. 3, a flow chart of a method of sending an audio message by mobile phones during communication via the system of FIG. 1 includes the following steps:

In Step S10: the detecting module 13 detects whether the mobile phone 10 is communicating with the remote terminal 50;

In Step S20: if the detecting module 13 detects that the mobile phone 10 is not communicating with the remote terminal 50, the detecting module 13 does nothing;

In Step S30: if the detecting module 13 detects that the mobile phone 10 is communicating with the remote terminal 50, the detecting module 13 transmits a busy signal to the central processing module 14, the central processing module 14 detects whether the touch-tone of the mobile phone 10 is turned on;

In Step S40: if the touch-tone is turned on, the central processing module 14 controls the touch-tone control module 15 to turn off the touch-tone;

In Step S50: if the touch-tone is turned off, the central processing module 14 transmits the busy signal to the storage module 12, the storage module 12 transmits the digital voice signal to the voice processing module 16 when a corresponding numeral key on the mobile phone 10 is pressed;

In Step S60: the voice processing module 16 coverts the digital voice signal to audible voice message, and transmits the audible voice message to the output control module 17;

In Step S70: the output control module 17 transmits the audible voice message from the voice processing module 16 to the wireless network 30 together with communicating voice message;

In Step S80: the wireless network 30 transmits the audible voice message and the communicating voice message to the remote terminal 50;

In Step S90: the remote terminal 50 hears the audible voice message together with the communicating voice message.

When a user of the mobile phone 10 answers a call and wants to end the telephone call as soon as possible, a corresponding numeral key on the mobile phone 10 is pressed to choose a voice message pre-stored in the storage module 12. The voice message, such as “it is time to attend a conference in the meeting room”, is then transmitted to the remote terminal 50. The remote terminal 50 hears the voice message together with the communicating voice message from the user. And the user can hang up the mobile phone 10 politely.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A system for transmitting an audio message by a mobile phone during communication with a remote terminal, comprising:
a detecting module being capable of detecting whether the mobile phone is communicating with the remote terminal, and outputting a busy signal when the mobile phone is communicating with the remote terminal;
a central processing module being capable of receiving the busy signal, detecting whether a touch-tone of the mobile phone is turned off, and outputting the busy signal when the touch-tone is turned off,
a storage module storing a plurality of digital voice signal for receiving the busy signal, and outputting the corresponding digital voice signal;
a voice processing module for converting the corresponding digital voice signal to audible voice message; and
an output control module for receiving the audible voice message, and transmitting the audible voice message from the voice processing module to the remote terminal.

2. The system of claim 1, further comprising an input control module for recording voice messages, and converting the recorded voice messages to digital voice signal, the input control module comprises a voice labeling module and a voice recording module, the voice labeling module comprises a plurality of information columns corresponding to different keys on the mobile phone, the voice recording module is used for recording voice messages.

3. The system of claim 1, further comprising a central processing module for receiving the busy signal, detecting whether a touch-tone of the mobile phone is turned off, and transmitting the busy signal to the storage module when the touch-tone is turned off.

4. The system of claim 3, further comprising a touch-tone control module for turning off the touch-tone of the mobile phone when the central processing module detects that the touch-tone is turned on.

5. A method for transmitting an audio message by a mobile phone during communication with a remote terminal, the method comprising the following steps:
a detecting module detecting whether the mobile phone is communicating with the remote terminal, and outputting a busy signal to a storage module when the mobile phone is communicating with the remote terminal;
the storage module transmitting corresponding digital voice signal to a voice processing module when receives the busy signal;
the voice processing module converting the corresponding digital voice signal to audible voice message, and transmitting the audible voice message to an output control module;
the output control module transmitting the audible voice message from the voice processing module to the remote terminal together with communicating voice message.

6. The method of claim 5, further comprising a central processing module receiving the busy signal, detecting whether a touch-tone of the mobile phone is turned off, and transmitting the busy signal to the storage module when the touch-tone is turned off.

7. The method of claim 6, further comprising a touch-tone control module turning off the touch-tone of the mobile phone when the central processing module detects that the touch-tone is turned on.
